(19) United States
(12) Patent Application Publication
(10) Pub. No.: US 2007/0128486 A1
(43) Pub. Date: Jun. 7, 2007

(54) Fuel cell system with waste-heat recovery

(76) Inventors: Charn-Ying Chen, Taoyuan City (TW); Peng Yang, Kaohsiung City (TW); Chun Lung Chang, Hu-ko (TW); Ying-Sheng Lee, Sindian City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/293,229

(22) Filed: Dec. 5, 2005

(51) Int. Cl. H01M 8/04

(52) U.S. Cl. 429/26; 429/34

(57) ABSTRACT

A fuel cell system enabling waste heat recovery includes an air supply unit and a fuel supply unit for supplying required air and methanol/water mixture, respectively, to the fuel cell stack for reaction. The methanol/water mixture is then expelled from the fuel cell stack after having been used in the reaction in the fuel cell stack. The methanol/water mixture is supplied to the fuel supply unit from a mixing tank, into which pure methanol and water are separately supplied and then mixed. Waste gas produced in the reaction in the fuel cell stack is expelled from the fuel cell stack and led into the mixing tank to evenly mix with the methanol/water mixture. Reaction heat produced in the reaction in the fuel cell stack may be recovered to heat the air supplied to the fuel cell stack to thereby upgrade the performance of the fuel cell stack.

### FIELD OF THE INVENTION

The present invention relates to a fuel cell system, and more particularly to a fuel cell system enabling waste-heat recovery.

### BACKGROUND OF THE INVENTION

A fuel cell is a power-generating unit that generates electrical energy through electrochemical reaction of hydrogen-containing fuel with air. Since the fuel cell has the advantages of low pollution, high efficiency, and high energy density, it has been actively researched, developed, and promoted in many countries. Among others, the proton exchange membrane fuel cell (PEMFC) is the most industrially valuable product due to its low operating temperature, quick activation, and high energy density.

In a fuel cell system using methanol as an anodic fuel, the fuel cell stack thereof includes an air inlet, a reaction-produced waste gas outlet, an anodic fuel inlet, and an anodic fuel outlet. In the reaction in the fuel cell system, air required at the cathode is supplied into the fuel cell stack via the air inlet. And, air having been used in the reaction is expelled as waste gas via the reaction-produced waste gas outlet.

On the other hand, anodic fuel required at the anode in the reaction in the fuel cell stack is supplied from a fuel supply unit, which supplies a mixture of pure methanol and water to the anodic fuel inlet of the fuel cell stack. And, excessive methanol that does not react with the air in the reaction is expelled via the anodic fuel outlet of the fuel cell stack.

In a general big-scaled fuel cell system, the fuel supply unit includes a pure methanol tank for storing pure methanol, a methanol pump, a circulation pump, and a water tank for storing water.

In the conventional fuel cell system using methanol as the anodic fuel for the fuel cell, pure methanol in the pure methanol tank and water in the water tank are separately supplied into a mixing tank and evenly mixed. The methanol/water mixture is then pumped by a circulation pump for supplying to the anodic fuel inlet of the fuel cell stack. However, it is frequently unable to thoroughly stir and evenly mix the pure methanol and the water using conventional mixing techniques.

Further, in the fuel cell system, the air having been used in the reaction in the fuel cell stack is expelled via the reaction-produced waste gas outlet. The expelled waste gas usually has a pretty high temperature. If the waste gas is simply exhausted without being recovered, the heat of the waste gas is wasted. On the other hand, the fuel cell must operate under proper temperature and humidity conditions to achieve the best possible performance. However, it is a pity the heat energy of the exhausted waste gas in the conventional fuel cell system has not been recovered and utilized in regulation of the temperature of the system.

### SUMMARY OF THE INVENTION

A primary object of the present invention is to provide a fuel cell system enabling waste-heat recovery, in which air source for supplying to a fuel cell stack for reaction is properly preheated by recovered waste gas produced in the reaction in the fuel cell stack.

Another object of the present invention is to provide a structurally simple air supply unit for a fuel cell system. In the air supply unit, there is provided waste gas conveying lines for recovering waste gas produced in the reaction in the fuel cell system and guiding the recovered waste gas to an air source to preheat air for supplying to a fuel cell stack of the fuel cell system for reaction.

A further object of the present invention is to provide a fuel cell system in which waste gas expelled from a fuel cell stack is guided into a mixing tank to enable thorough stirring and even mixing of methanol with water in the mixing tank.

A still further object of the present invention is to provide a fuel cell system enabling full use of reaction heat produced in the reaction in a fuel cell stack as a heat source to preheat air for supplying to the fuel cell stack for reaction, so as to upgrade the performance of the fuel cell system.

A still further object of the present invention is to provide a fuel cell system in which a cover is provided to enclose a fuel cell stack therein, so that air in the cover is supplied to the fuel cell stack for reaction, and reaction heat produced in the reaction in the fuel cell stack is partially recovered for use.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 schematically shows a fuel cell system enabling waste heat recovery according to a first embodiment of the present invention;

FIG. 2 schematically shows a fuel cell system enabling waste heat recovery according to a second embodiment of the present invention;

FIG. 3 schematically shows a fuel cell system enabling waste heat recovery according to a third embodiment of the present invention; and

FIG. 4 schematically shows a fuel cell system enabling waste heat recovery according to a fourth embodiment of the present invention.

### DETAILED DESCRIPTION OF THE PREFERRED EMBODIMENTS

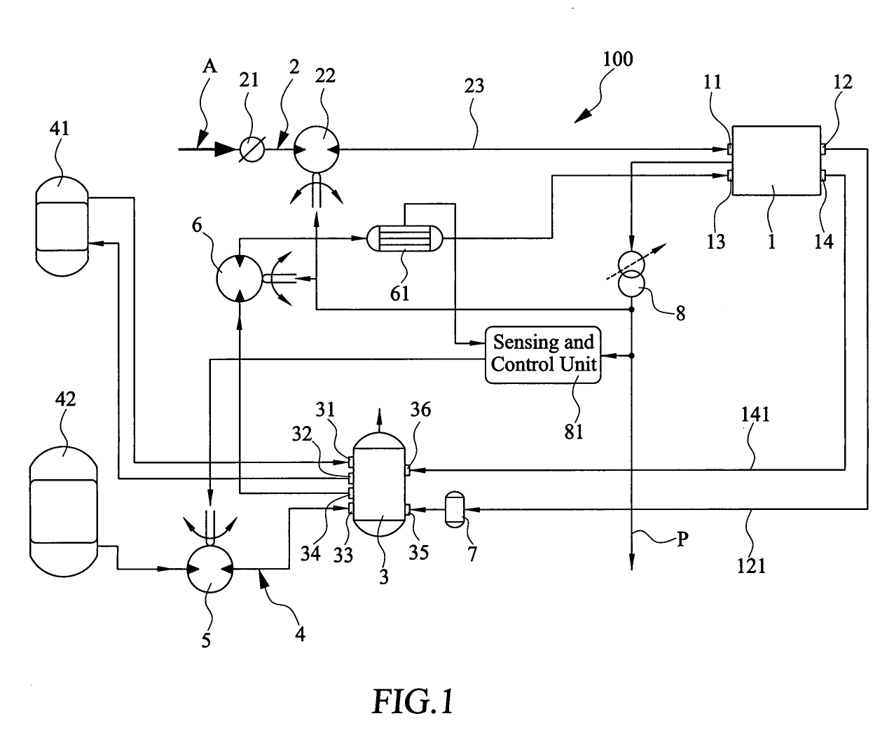

Please refer to FIG. 1 that schematically shows a fuel cell system enabling waste heat recovery 100 according to a first embodiment of the present invention. As shown, the fuel cell system enabling waste heat recovery 100 in the first embodiment includes a fuel cell stack 1, an air supply unit 2, a mixing tank 3, a fuel supply unit 4, and an air/water separator 7.

The fuel cell stack 1 has an air inlet 11, a reaction-produced waste gas outlet 12, an anodic fuel inlet 13, and an anodic fuel outlet 14.

Air required in the reaction in the fuel cell stack 1 is supplied from an air source A via the air supply unit 2 to the air inlet 11 of the fuel cell stack 1. The air supply unit 2 includes an air filter 21, an air pump 22, and an air conveying line 23 led to the air inlet 11. Air having been used in the reaction in the fuel cell stack 1 is then expelled as waste gas from the reaction-produced waste gas outlet 12.

The mixing tank 3 includes a water inlet 31, a water outlet 32, a methanol inlet 33, a methanol-water mixture outlet 34, a waste gas/water inlet 35, and an expelled anodic fuel inlet 36. The waste gas/water inlet 35 is communicable with the reaction-produced waster gas outlet 12 of the fuel cell stack 1 via a waste gas conveying line 121, and the expelled anodic fuel inlet 36 is communicable with the anodic fuel outlet 14 of the fuel cell stack 1 via an expelled anodic fuel conveying line 141.

The fuel required in the reaction in the fuel cell stack 1 is supplied from the fuel supply unit 4 to the fuel cell stack 1. The fuel supply unit 4 includes a water tank 41, a pure methanol tank 42, a methanol pump 5, and a circulation pump 6. The water tank 41 and the pure methanol tank 42 store water and pure methanol, respectively. The water stored in the water tank 41 is supplied to the mixing tank 3 via a water-conveying line and the water inlet 31 on the mixing tank 3. The pure methanol stored in the pure methanol tank 42 is supplied to the mixing tank 3 via the methanol pump 5 and the methanol inlet 33 on the mixing tank 3.

The pure methanol and the water separately supplied to the mixing tank 3 are mixed in the mixing tank 3, and the mixture of pure methanol and water is then pumped by the circulation pump 6 from the methanol/water mixture outlet 34 and supplied to the fuel cell stack 1 via the anodic fuel inlet 13 for use as the anodic fuel needed in the reaction in the fuel cell stack 1. A methanol concentration sensor 61 may be mounted on a communicating line between the circulation pump 6 and the anodic fuel inlet 13 of the fuel cell stack 1 for detecting the concentration of the methanol/water mixture.

Before the waste gas expelled from the reaction-produced waste gas outlet 12 of the fuel cell stack 1 is guided to the waste gas/water inlet 35 of the mixing tank 3 via the waste gas conveying line 121, it first passes the gas/water separator 7, so that water contained in the expelled waste gas is separated from the waste gas. Thereafter, water separated from the expelled waste gas by the gas/water separator 7 is guided into the mixing tank 3 via the waste gas/water inlet 35, and then evenly mixed with the methanol in the mixing tank 3 through thorough stirring.

An excessive part of the pure methanol that is supplied to the fuel cell stack 1 for use as the anodic fuel but is not reacted with the air, which is used as the cathodic fuel, is expelled via the anodic fuel outlet 14 of the fuel cell stack 1 and guided to the expelled anodic fuel inlet 36 of the mixing tank 3 via the expelled anodic fuel conveying line 141, and be recovered.

In a circuit system of the fuel cell system enabling waste heat recovery, there is a DC-DC converter 8. Power generated during the reaction in the fuel cell stack 1 is converted by the DC-DC converter 8 to supply a predetermined output voltage. The circuit system also includes a sensing and control unit 81, which is adapted to detect an output power P produced by the DC-DC converter 8, and use the methanol/water mixture concentration detected by the methanol concentration sensor 61 to control the methanol pump 5 to supply a proper amount of methanol.

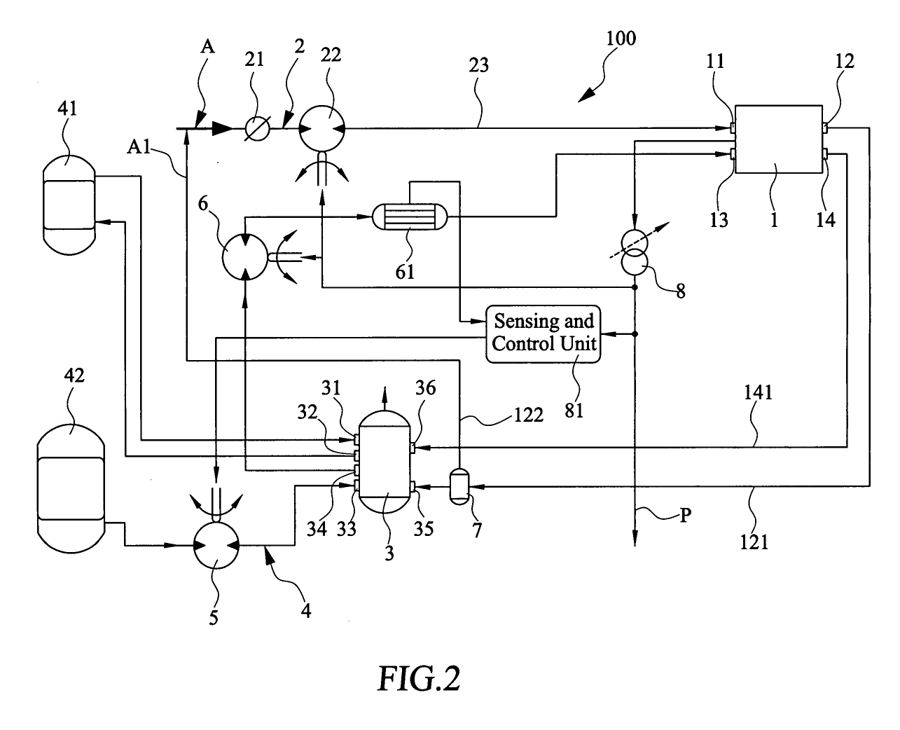

FIG. 2 schematically shows a fuel cell system enabling waste heat recovery 100 according to a second embodiment of the present invention. The second embodiment is generally structurally similar to the first embodiment, except for a waste gas conveying branch line 122 extended from the gas/water separator 7 to the air filter 21 of the air supply unit 2. When the waste gas expelled from the reaction-produced waste gas outlet 12 is separated from water at the gas/water separator 7, it is guided by the waste gas conveying branch line 122 to the air filter 21 and used as part of the air source A, and then be pumped by the air pump 22 for supplying to the fuel cell stack 1 via the air conveying line 23. That is, a part of the air source sucked in by the air pump 22 is the room air while the other part of the sucked-in air source is the waste gas expelled from the reaction-produced waste gas outlet 12 of the fuel cell stack 1. In other words, the waste gas expelled after the reaction in the fuel cell stack 1 is divided into two parts, a first of which is recovered and guided to the air (or cathodic fuel) inlet 11 of the fuel cell stack 1, and a second of which is discharged into the ambient air. The part of the expelled waste gas being recovered and guided to the air inlet 11 of the fuel cell stack 1 heats the room air supplied to the air inlet 11, and thereby shortens the time needed by the fuel cell stack 1 to rise from a room temperature to a required operating temperature thereof.

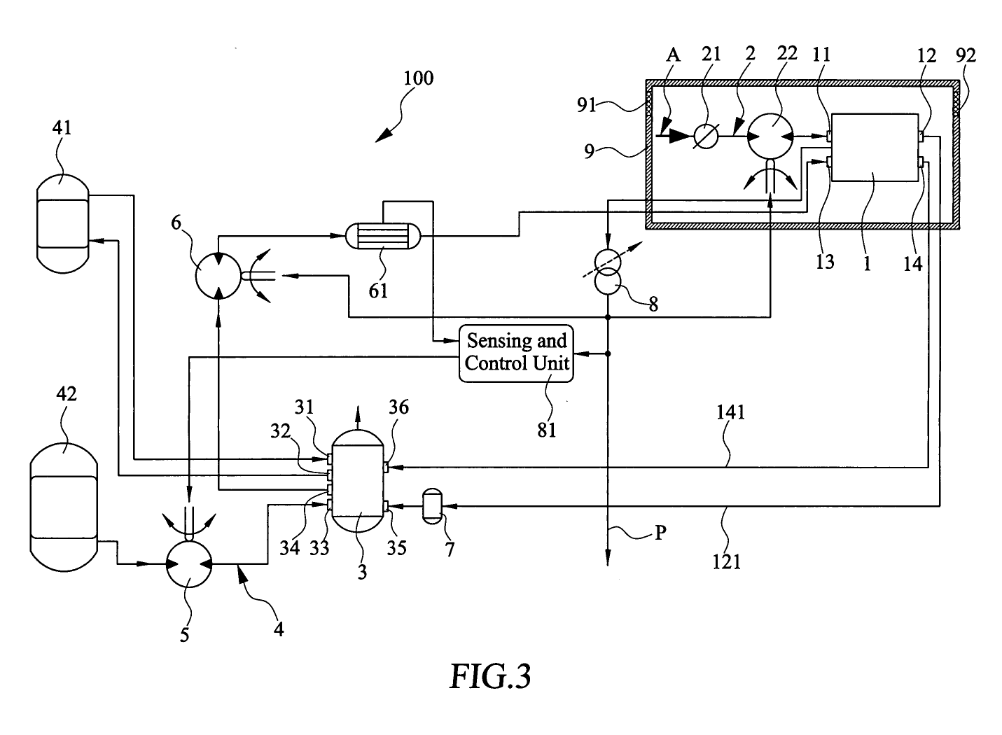

Please refer to FIG. 3 that schematically shows a fuel cell system enabling waste heat recovery 100 according to a third embodiment of the present invention. The third embodiment is generally structurally similar to the previous embodiments, except for a cover 9 that defines an inner space to enclose the whole fuel cell stack 1 as well as the air filter 21 and the air pump of the air supply unit 2 therein. The cover 9 is pre-formed at predetermined positions with an air intake opening 91 and an air exhaust opening 92. With these arrangements, reaction heat produced during the reaction in the fuel cell stack 1 is restricted within the inner space of the cover 9 and sucked by the air pump 22 via the air filter 21 for supplying to the air inlet 11 of the fuel cell stack 1 again.

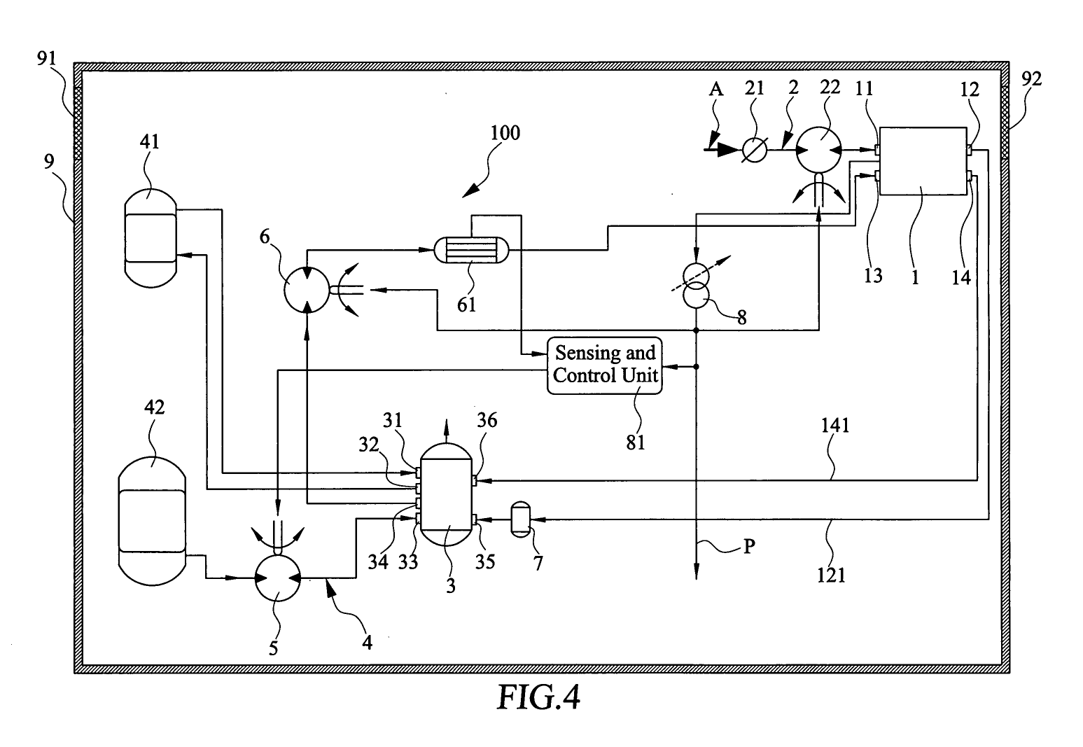

In the third embodiment shown in FIG. 3, the cover 9 encloses only the fuel cell stack 1 as well as the air filter 21 and the air pump of the air supply unit 2 therein. However, in implementing the present invention, it is also possible to provide an expanded cover 9 for also enclosing all other components of the fuel cell system enabling waste heat recovery, as a fourth embodiment of the present invention shown in FIG. 4. That is, in the fourth embodiment, the whole fuel cell stack 1; the whole air supply unit 2, including the air filter 21 and the air pump 22; the mixing tank 3; the fuel supply unit 4, including the water tank 41, the pure methanol tank 42, the methanol pump 5, and the circulation pump 6; the methanol concentration sensor 61; the DC-DC converter 8; and the sensing and control unit 81 all are enclosed in the expanded cover 9.

What is claimed is:

1. A fuel cell system enabling waste heat recovery, comprising:
a fuel cell stack having an air inlet, a reaction-produced waste gas outlet, an anodic fuel inlet, and an anodic fuel outlet;
an air supply unit including an air source led to said air inlet of said fuel cell stack for supplying required air to said fuel cell stack for reaction with an anodic fuel; and air having been used in the reaction being expelled as waste gas via said reaction-produced waste gas outlet of said fuel cell stack;
a fuel supply unit for supply required methanol/water mixture, which is the anodic fuel, to said fuel cell stack for reaction with air supplied by said air supply unit to said fuel cell stack; said methanol/water mixture being supplied to said fuel cell stack via said anodic fuel inlet, and then expelled via said anodic fuel outlet after having been used in the reaction in said fuel cell stack;
a waste gas conveying line for guiding out said reaction-produced waste gas expelled via said reaction-produced waste gas outlet of said fuel cell stack; and
a mixing tank including a methanol inlet via which pure methanol is supplied into said mixing tank, a methanol/water mixture outlet, a water inlet via which water is supplied into said mixing tank, and a water outlet; the pure methanol and the water supplied into said mixing tank being mixed in said mixing tank to provide said methanol/water mixture for supplying from said fuel supply unit to said fuel cell stack via said anodic fuel inlet; said mixing tank further including a waste gas/water inlet, which is communicable with said reaction-produced waste gas outlet of said fuel cell stack via a gas/water separator and said waste gas conveying line, such that waste gas expelled from said reaction-produced waste gas outlet of said fuel cell stack is guided into said mixing tank via said waste gas/water inlet for evenly mixing with said methanol/water mixture in said mixing tank through thorough stirring.

2. The fuel cell system enabling waste heat recovery as claimed in claim 1, wherein said air supply unit includes an air pump and an air conveying line communicating said air pump with said air inlet of said fuel cell stack, so as to supply said air source to said fuel cell stack via said air inlet.

3. The fuel cell system enabling waste heat recovery as claimed in claim 2, wherein said air pump sucks in said air source via an air filter.

4. The fuel cell system enabling waste heat recovery as claimed in claim 1, wherein said fuel supply unit includes a pure methanol tank and a water tank for storing said pure methanol and said water, respectively, to be supplied to said mixing tank.

5. The fuel cell system enabling waste heat recovery as claimed in claim 4, wherein said fuel supply unit further includes a methanol pump and a circulation pump, said pure methanol stored in said pure methanol tank being pumped into said mixing tank by said methanol pump; and said pure methanol and said water supplied into and mixed in said mixing tank being supplied from said methanol/water mixture outlet of said mixing tank via said circulation pump to said anodic fuel inlet of said fuel cell stack.

6. A fuel cell system enabling waste heat recovery, comprising:
a fuel cell stack having an air inlet, a reaction-produced waste gas outlet, an anodic fuel inlet, and an anodic fuel outlet;
an air supply unit including an air source led to said air inlet of said fuel cell stack for supplying required air to said fuel cell stack for reaction with an anodic fuel; and air having been used in the reaction producing waste gas that is expelled via said reaction-produced waste gas outlet of said fuel cell stack;
a fuel supply unit for supply required fuel to said fuel cell stack for reaction with air supplied by said air supply unit to said fuel cell stack; said fuel being supplied to said fuel cell stack via said anodic fuel inlet, and then expelled via said anodic fuel outlet after having been used in the reaction in said fuel cell stack;
a waste gas conveying line for guiding out said reaction-produced waste gas expelled via said reaction-produced waste gas outlet of said fuel cell stack; and
a waste gas conveying branch line for guiding said waste gas expelled into said waste gas conveying line to said air supply unit for use as a part of said air source supplied by said air supply unit to said fuel cell stack for reaction.

7. The fuel cell system enabling waste heat recovery as claimed in claim 6, further comprising a mixing tank; said mixing tank including a methanol inlet, a methanol/water mixture outlet, a water inlet, and a water outlet; and said fuel supplied by said fuel supply unit including pure methanol and water, which are supplied to said mixing tank via said methanol inlet and said water inlet, respectively, to provide a methanol/water mixture for supplying to said fuel cell stack via said anodic fuel.

8. The fuel cell system enabling waste heat recovery as claimed in claim 7, wherein said mixing tank further comprising a waste gas/water inlet, which is communicable with said reaction-produced waste gas outlet of said fuel cell stack via a gas/water separator and said waste gas conveying line, such that waste gas expelled from said reaction-produced waste gas outlet of said fuel cell stack is guided into said mixing tank via said waste gas/water inlet for evenly mixing with said methanol/water mixture in said mixing tank through thorough stirring.

9. A fuel cell system enabling waste heat recovery, comprising:
a fuel cell stack having an air inlet, a reaction-produced waste gas outlet, an anodic fuel inlet, and an anodic fuel outlet;
a cover defining an inner space for enclosing said fuel cell stack therein;
an air supply unit obtaining an air source in said inner space of said cover and leading said air source to said air inlet of said fuel cell stack for supplying required air to said fuel cell stack for reaction with an anodic fuel; and air having been used in the reaction producing waste gas that is expelled via said reaction-produced waste gas outlet of said fuel cell stack; and
a fuel supply unit for supply required methanol/water mixture to said fuel cell stack for reaction with air supplied by said air supply unit to said fuel cell stack; said methanol/water mixture being supplied to said fuel cell stack via said anodic fuel inlet, and then expelled via said anodic fuel outlet after having been used in the reaction in said fuel cell stack.

10. The fuel cell system enabling waste heat recovery as claimed in claim 9, wherein said air supply unit includes an air pump and an air conveying line communicating said air pump with said air inlet of said fuel cell stack, so as to supply said air source to said fuel cell stack via said air inlet; and said air pump being enclosed in said inner space defined by said cover.

11. The fuel cell system enabling waste heat recovery as claimed in claim 10, wherein said air pump sucks in said air source via an air filter.

12. The fuel cell system enabling waste heat recovery as claimed in claim 9, further comprising:
a waste gas conveying line for guiding out said reaction-produced waste gas expelled via said reaction-produced waste gas outlet of said fuel cell stack; and
a mixing tank including a methanol inlet via which pure methanol is supplied into said mixing tank, a methanol/water mixture outlet, a water inlet via which water is supplied into said mixing tank, and a water outlet; the pure methanol and the water supplied into said mixing tank being mixed in said mixing tank to provide said methanol/water mixture for supplying to said fuel cell stack via said anodic fuel inlet; said mixing tank further including a waste gas/water inlet, which is communicable with said reaction-produced waste gas outlet of said fuel cell stack via a gas/water separator and said waste gas conveying line, such that waste gas expelled from said reaction-produced waste gas outlet of said fuel cell stack is guided into said mixing tank via said waste gas/water inlet for evenly mixing with said methanol/water mixture in said mixing tank through thorough stirring.

13. The fuel cell system enabling waste heat recovery as claimed in claim 9, wherein said air supply unit and said fuel supply unit are enclosed in said inner space of said cover.
